(19) United States
(12) Patent Application Publication
(10) Pub. No.: US 2007/0098243 A1
(43) Pub. Date: May 3, 2007

(54) Smart destination image routing system

(76) Inventor: Gregory A. Gustafson, Independence, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/443,742

(22) Filed: May 31, 2006

Related U.S. Application Data
(60) Provisional application No. 60/731,650, filed on Oct. 28, 2005.

(51) Int. Cl. G06K 9/00

(52) U.S. Cl. 382/132

(57) ABSTRACT

A smart destination image scanning and routing system and a method of routing digital mammogram images. The system and method can include a configuration editor that utilizes a graphical user interface (“GUI”) through which a user can quickly and easily turn image destinations on or off by creating criteria for each destination, thus dictating the default for circumstances under which the destinations will receive the images. Users therefore need not open and manually edit the code in a configuration file to route and reroute images.

### RELATED APPLICATION

This application claims the benefit of U.S. Provisional Application No. 60/731,650, filed Oct. 28, 2005, which is incorporated herein by reference in its entirety.

### COMPACT DISC

A compact disc containing codes and information describing a preferred embodiment of the present invention is submitted herewith and is hereby incorporated by reference. The compact disc contains the following files and/or programs:

| Title | Size in Bytes | Date of Creation |
|---|---|---|
| DICOMDestination.txt | 7,123 | Oct. 27, 2005 |
| DICOMG.txt | 30,670 | Oct. 27, 2005 |
| DlgMain.txt | 122,233 | Oct. 27, 2005 |
| frmEditDestination.txt | 11,633 | Oct. 27, 2005 |
| SmartDestination.txt | 13,687 | Oct. 27, 2005 |
| SmartDestinationEditor.txt | 1,151 | Oct. 27, 2005 |

### FIELD OF THE INVENTION

The present invention relates generally to image routing systems. More particularly, the present invention relates to a mammogram image routing system for a mammogram image scanner that enables a user to select and modify the destinations to which scanned mammogram images are sent.

### BACKGROUND OF THE INVENTION

Recently, Digital Imaging and Communications in Medicine systems (“DICOM”) have become conventional imaging systems for distributing and viewing medical studies and images. The use of DICOM has, among other things, enabled industry compatibility and improved workflow efficiency between imaging and other information systems located in various healthcare environments.

Conventional imaging systems enable a DICOM Service Class User (“SCU”) to send images across a network to other DICOM Service Class Providers (“SCPs”) on the network. Some examples of DICOM SCPs include Picture Archiving and Communications Systems (“PACS”), softcopy workstations, computer-aided diagnosis (“CAD”) systems, DICOM CD/DVD burners, and other network systems known to those skilled in the art.

To receive a transmission, the DICOM SCPs generally must be identified within the SCU system prior to transmission. Each SCP is generally identified with a unique Internet Protocol (“IP”) address, Application Entry (“AE”) Title, and port number. The SCPs are typically identified through lines of code in an Extendable Markup Language (.xml) or an initialization (.ini) file. Once the SCPs are identified in the .xml or initialization (.ini) file, the SCPs are generally considered to be “on.” In other words, once an image is transmitted by an SCU system, each SCP that is identified in the SCU system and is “listening” will automatically receive the image or set of images.

To turn an SCP on or off, a user generally must open a configuration file, such as an .xml or .ini file, and manually edit the particular line of code for that particular SCP. The change generally does not become effective until the configuration file has been saved and the program has been restarted. This can lead to increased workflow times.

In particular situations, however, it may not be desirable to transmit the image or images to every SCP that is identified and defined on the network. This can lead to inefficient management of the SCPs and unnecessary increases in network traffic. In addition, many vendors generally prefer that only qualified individuals have access to certain files for editing. As such, if a user determines that an SCP should be turned on or off, many persons might need to be contacted to turn the SCP off. This can potentially lead to significant turnaround times to send and/or receive scanned images.

Because the deficiencies discussed above have not been addressed by conventional image routing systems, there is a current need for a smart destination image routing system addressing the problems and deficiencies inherent with conventional designs.

### SUMMARY OF THE INVENTION

The smart destination image router of the present invention substantially solves the deficiencies inherent with conventional image routing systems by providing a system that enables a user to quickly turn destinations on or off and by creating criteria for each SCU, thus dictating the default for circumstances under which the destinations will receive the images.

A feature and advantage of the present invention is that users need not open and manually edit the code in a configuration file to route images and change destinations. The system according to the various embodiments of the present invention can include a destination configuration editor that utilizes a graphical user interface (“GUI”) through which a user can quickly and easily change the settings.

### BRIEF DESCRIPTION OF THE DRAWINGS

FIG. 1 is a system block diagram according to one embodiment of the present invention.

FIG. 2 is a block diagram of a scanner according to one embodiment of the present invention.

FIG. 3 is a selected portion of a graphical user interface (GUI) according to one embodiment of the present invention.

FIG. 4 is another selected portion of a GUI according to one embodiment of the present invention.

FIG. 5 is another selected portion of a GUI according to one embodiment of the present invention.

FIG. 6 is another selected portion of a GUI according to one embodiment of the present invention.

FIG. 7 is another selected portion of a GUI according to one embodiment of the present invention.

FIG. 8 is a scanner GUI page according to one embodiment of the present invention.

FIG. 9 is a flowchart of a method according to one embodiment of the invention.

### DETAILED DESCRIPTION OF THE INVENTION

The smart destination image router according to the present invention provides increased efficiency and workflow when transmitting DICOM images. The increased efficiency can be achieved by enabling a user to quickly turn destinations on or off and by creating criteria for each SCU, thus dictating the default circumstances under which the destinations will receive the images. Opening and editing configuration code to make destination changes is therefore unnecessary.

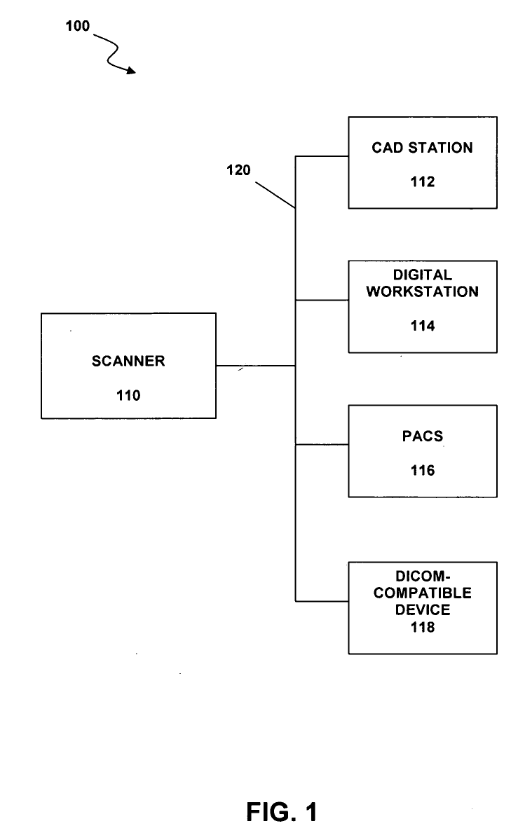

Referring to FIG. 1, a medical imaging system 100 according to one example embodiment comprises a scanner 110, a computer-aided diagnosis (CAD) system 112, a digital workstation 114, a picture archiving and communications system (PACS) 116, and one or more other DICOM-compatible device 118. Devices 110, 112, 114, 116, and 118 are generally mammogram image handling devices, wherein the mammogram images can be hardcopy films, digital mammogram image files, or both, depending upon the function and compatibility of a particular device. System 100 further comprises a network 120 communicatively coupling the devices 110, 112, 114, 116, and 118 of system 100. Network 120 facilitates communications and data exchanges among the devices 110, 112, 114, 116, and 118 of system 100 and can comprise, in whole or in part, a wired network, a wireless network, a local area network (LAN), a wide area network (WAN), an Intranet system, the Internet, or some other computer, cable, or telecommunications network.

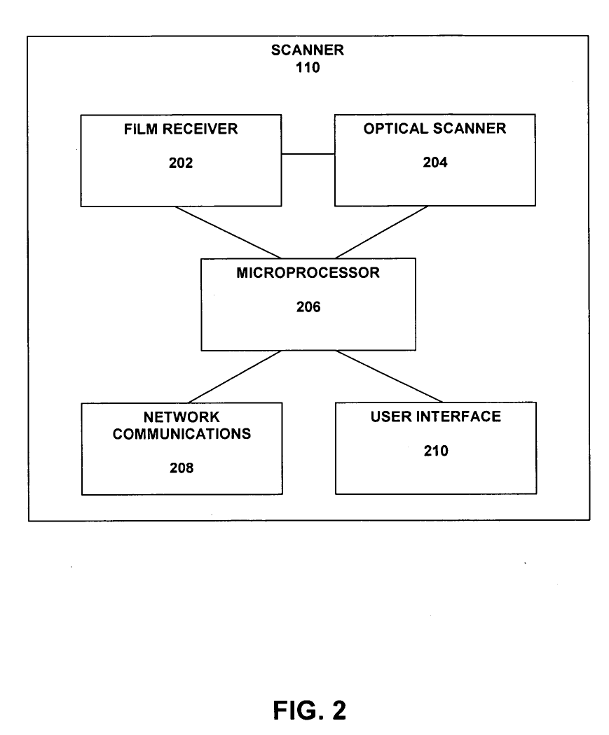

Scanner 110 is operable to scan and digitize x-ray or other hardcopy films for use within or incorporation by other devices of system 110. In one embodiment, scanner 110 receives a hardcopy x-ray film and produces a DICOM-compatible image file related to the hardcopy film that can be digitally transferred, accessed, or stored. Referring to FIG. 2, scanner 110 comprises a film receiver 202, such as an automatic or manual feeder, hopper, or other input means; a scanner or other film digitizer, such as an optical scanner 204; a microprocessor 206 or other control module; a communications module 208 coupling scanner 110 to network 120 and otherwise facilitating incoming and outgoing communications with system 100 and other external devices; and a user interface 210 comprising, in one embodiment, input and output devices such as a keyboard, keypad, mouse, display, touchscreen and/or other indicators and devices facilitating control of and communication with scanner 110 by a user, including through a graphical user interface (GUI) hosted and controlled by microprocessor 206. In one embodiment, scanner 110 comprises a PENSCAN system commercially available from PenRad Technologies, Inc., of Plymouth, Minn., the assignee of the present invention. In another embodiment, scanner 110 is omitted or bypassed, and images are digitally acquired by system 100 directly from an x-ray device or other medical system communicatively coupled to network 120. More commonly, however, film images will be digitized by scanner 110 for routing within system 100.

CAD system 112 is a partially or fully automated system that assists in the review and analysis of medical data and information, including medical images and X-rays. PACS 116 is a medical image storage system. DICOM-compatible device 118 can comprise a medical information device, an image acquisition or analysis device, a user interface device, or some other relevant DICOM-compatible device. The number and type of devices of system 100 can vary from as depicted in FIG. 1 in other embodiments. For example, another medical imaging system 100 may comprise a scanner 110, a CAD station 112, three digital workstations 114, and a PACS 116, or some other number and/or type of compatible medical equipment.

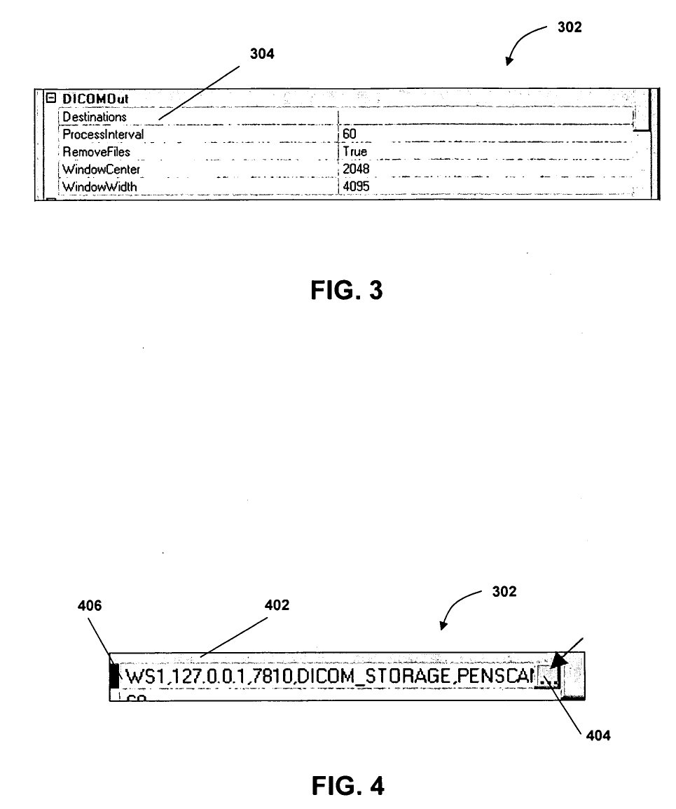

According to one embodiment of the present invention, scanner 110 comprises a smart destination image routing system. The image routing system is operable to automate and control the routing within system 100 of image files created by scanner 110. In one embodiment, the image files relate to mammograms or mammogram studies, although other medical images can also be handled and managed within system 100. Configuration and editing of the smart destination image routing system are described below with reference to FIGS. 3-8.

Referring to FIG. 3, a destination portion 304 of a GUI 302, operating as part of user interface 210 of scanner 110, is depicted. Destination portion 304 provides access to the options for the DICOM images produced by scanner 110, including the destination settings for scanner 110 and system 100. To use and configure the smart destination image routing system of the present invention, a user can select destination portion 304. The particular selection methodology can vary in accordance with the features and functions of scanner 110, in particular user interface 210. In one embodiment, a user can select destination portion 304 by tapping on a touchscreen displaying GUI 302 of user interface 210. In other embodiments, selection can be accomplished using a keyboard, mouse, or other peripheral device.

A destination setting portion 402 can then appear on GUI 302, as depicted in FIG. 4. Destination setting portion 402 can include a destination editing link 404 and a data field 406 containing a textual identifier of a currently selected destination within system 100. In one embodiment, the destination identifier is an IP address of a device, such as CAD station 112, digital workstation 114, PACS 116, or device 118, communicatively coupled to network 120 of system 100. Data field 406 might or might not have displayed data, depending on whether any destinations have been previously selected.

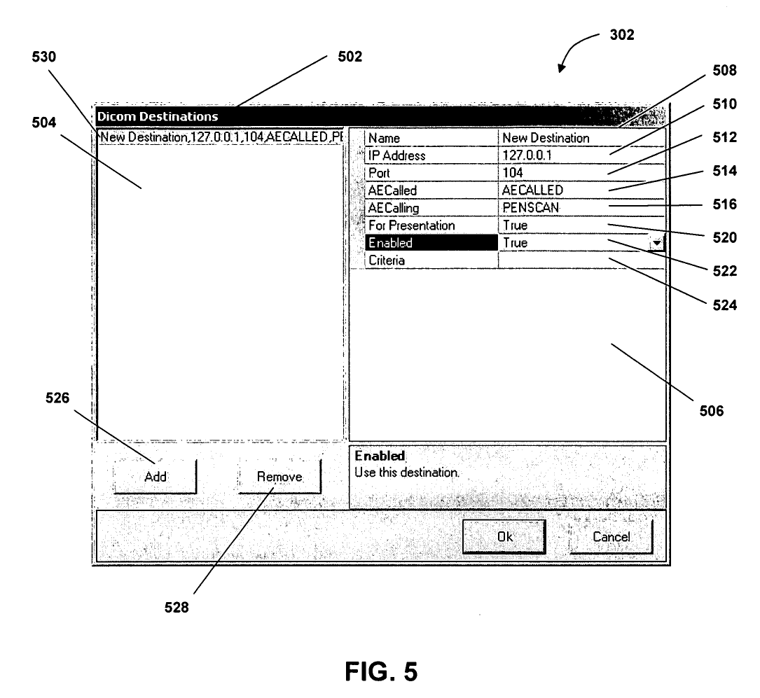

A DICOM destination editor 502 is generally depicted in FIG. 5. Destination editor 502 can be reached by selecting destination editing link 404 (FIG. 4). If any available destinations for a user's system 100 have previously been entered, destination editor 502 will then display the available destinations in a first pane 504 of destination editor 502 and any specific information, e.g., name of the destination, IP address, the port that the destination is monitoring, the AE Title of the destination, etc., for the selected destination in a second pane 506. If no destinations have previously been entered or selected, panes 504 and 506 will generally both be blank.

Depending on the length of the information, pane 504 can display the name of a selected destination, the IP address of the destination, the port that the destination is monitoring, the AE Title of the destination, the AE Title of the system software if the destination is enabled, and whether there are any criteria set. If the information is not visible, pane 504 can be selected to display configuration editor settings 508 in second pane 506 of destination editor 502.

Configuration editor settings 508 enable a user to quickly and easily change various settings of the smart destination image router of the present invention. These settings include, but are not limited to, a name of the destination 510, an IP address of the destination 512, a port of the destination 514, an AE Called indicator 516, an AE Calling indicator 518, an indicator 520 of whether the destination is for presentation, an indicator 522 of whether the destination is enabled, and any criteria for the destination 524. Name 510 is a name or short description of a destination. Port 514 is a port that the destination listens to for DICOM. AE Called indicator 516 is an AE title of the destination. AE Calling 518 is an AE title of scanner 110. Indicator 520 is a true/false indicator of whether images sent, as determined by the destination, are presentation or for processing. “True” indicates presentation format, and “False” indicates processing format. Indicator 522 turns the destination of scanner 110 on or off; “True” indicates on. Criteria 524 are smart destination criteria, including filters for the routing of studies to particular destinations.

Destination editor 502 can also include an “Add” button 526 to enable addition of a new destination and “Remove” button 528 to enable removal of a destination. To add a new destination, a user can tap or otherwise select the button 526, and a generic new destination with default settings will then be created by the imaging routing system of scanner 110. The user can then enter and save the desired name and settings for the new destination.

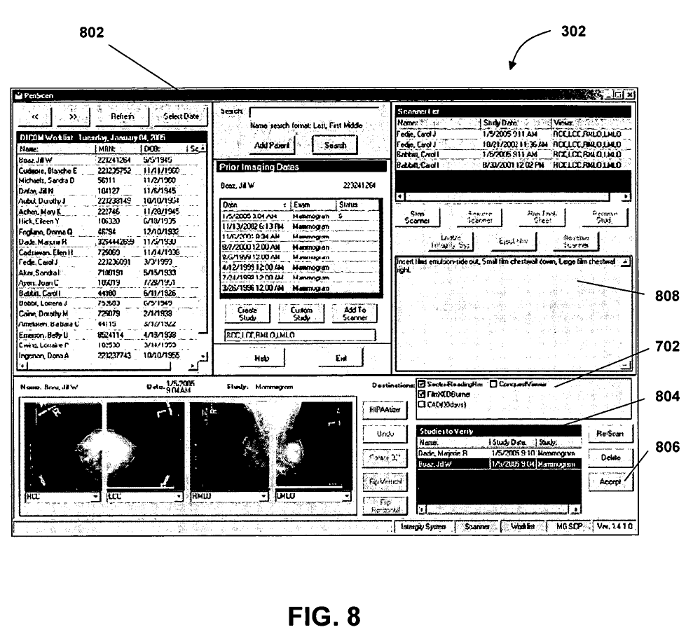

A destination can also be disabled or removed entirely from the system. In a disabled state, the destination settings will remain in the system, but the system will inhibit any studies or images from being sent to that location associated with the destination and its settings. To disable the destination, a user can change enabled field 522 to “False”. The destination can be enabled at a later date, thus eliminating any need to re-enter all the settings associated with the destination. If a destination is in a “disabled” state (Enabled=False) in the configuration editor, a user can temporarily override the system and enable the destination simply by selecting the destination as described in more detail below with reference with FIGS. 7 and 8, without having to directly edit the configuration file. That destination will remain enabled until the program is shut down and restarted. Upon restart, the program will read the configuration file, and the destinations will be “on” or “off” based on the settings in the configuration file. To remove a destination, a user can select the destination 28 and then select “Remove” button 528. All configuration settings can then be removed from the system.

Advantageously, and as mentioned briefly above, configuration editor settings 508 enable a user to avoid having to open and manually edit the code in a configuration file of microprocessor 206. To view or change the settings of a current destination of scanner 110, a user can select a desired destination 530. Configuration editor settings 508 for that destination 330 will then be displayed in pane 506. In one embodiment, some or all of fields 510-524 can be free text fields, although fields 522 and 544 can also comprise drop-down menus. To make a change in any of the fields, a user can place a cursor in or otherwise select a desired field, delete the previous entry, and enter any new data. To edit fields 522 and 524, a user can select the drop-down menu and make the selection from the provided options. The newly selected option will then be displayed in that field.

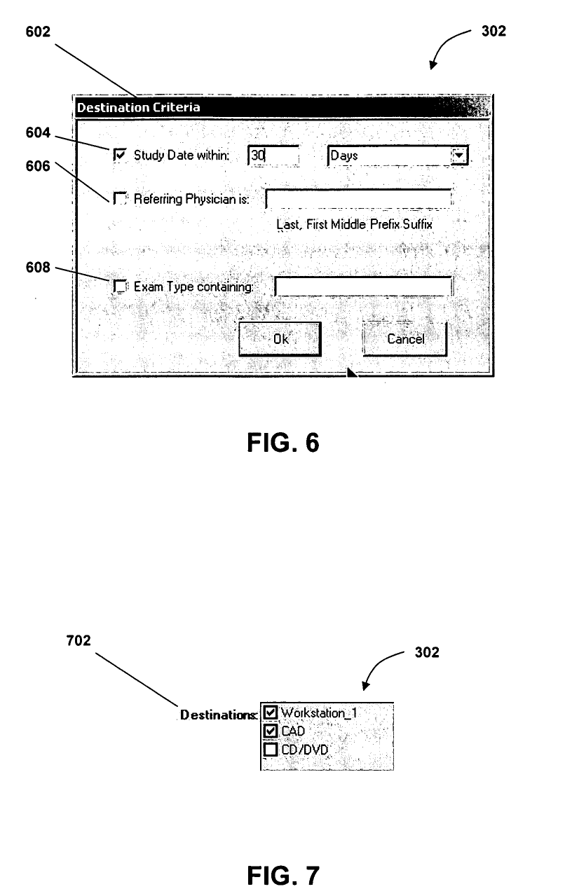

Referring to FIG. 6, a Destination Criteria editor 602 of GUI 302 is depicted. The present invention can further provide the ability to create “smart” destinations. Destinations can be configured to be “smart,” requiring that special or specified criteria be met for a study or image to be sent to the destination. Referring again to FIG. 5, Criteria field 524 contains a separate window for configuring its settings. A user selecting Criteria field 524 will display a link to Destination Criteria editor 602, as depicted in FIG. 5.

In one embodiment, Destination Criteria editor 602 includes fields and options for establishing or changing criteria related to “smart” destinations within system 100. Criteria can include a study date 604, a physician 606, and an exam type 608, as well as other criteria for filtering, sorting, and differentiating images. Study date 604 can be specified in days, months, or years. For example, a user can specify 30 days, 3 months, or 2 years. Study date 604 is often used to determine whether an image should be sent to CAD station 112. Typically, older or previous studies are not sent through CAD, therefore setting a 30-day criterion, for example, would prevent any study older than 30 days from being transmitted to that destination.

Additional criteria can specify that only images associated with a specific referring physician would be sent to a particular destination within system 100, or that only certain exam types, such as screening mammograms or diagnostic mammograms, be sent to the destination. For physician criteria 606, a user can enter a physician's information. Exam type criteria 608 is a free text field, and multiple words can be entered into this field of Destination Criteria editor 602. Some examples include screening, diagnostic, and other exam types known to those skilled in the art. The smart destination image router of the present invention will then search the exam type field of each image or study processed for any of the words entered in this field. If, for example, the destination includes exam type criterion 608 of “screening,” only studies that contain the word “screening” in the name of the exam type would be sent to the corresponding specified destination.

To select any of destination criteria 604, 606, or 608, a user can put a check mark in the corresponding respective check boxes in the embodiment depicted in FIG. 6. Alternate selection methodologies and options can be used in other embodiments of the invention. Preferably, any combination of criteria 604, 606, and 608 can be selected. For example, setting exam type criteria 608 to “Diagnostic” and study date criteria 604 to “30 days” would send any diagnostic study less than or equal to 30 days old to the corresponding selected destination. Any diagnostic studies older than 30 days or any screening studies can then be sent to a different viewing workstation. In this case, both criteria 604 and 608 would need to be met for the destination to be enabled.

Additional criteria can also be added. A specific calendar date can be used, such that any study before or after that date would be sent to a particular destination. Using calendar dates would also allow a criterion to be configured to accept a date range, such that any study falling within that date range would be sent to a specific destination. Another criterion might depend on the patient's age or another demographic factor. This criterion would be beneficial when a facility is participating in a clinical study, such as monitoring breast cancer for a specific age group. An additional criterion can be based on gender.

Available destinations within system 100 can also be specified. After a study image is scanned by scanner 110 and the demographic information of the patient associated with the image is verified, available destinations within system 100 can be displayed in a Destinations pane 702 on GUI 302 of scanner 110. Destinations pane 702 comprises a portion of a main screen 802 of GUI 302 of scanner 110, one example of which is depicted in FIG. 8. A destination listed in pane 702 but differentiated, such as by a differently colored text print, font, or format, indicates that the selected study did not meet the specific criteria for that destination. The study can still be sent to that destination by manually overriding the criteria for that destination, if desired. To override the criteria, a user can select or deselect a desired destination listed in Destination pane 702, regardless of whether the destination met the criteria. In one embodiment, a manual override will remain in effect until a user restarts scanner 110.

After a film or study has been checked for quality control and the destination verified in screen 802, a user can select the desired study in a study listing pane 804 and select accept 806 to begin processing and transmission. Once the destination (or destinations) has responded to scanner 110 indicating that the image or study has been successfully received, a log window 808 will indicate the study has been successfully processed.

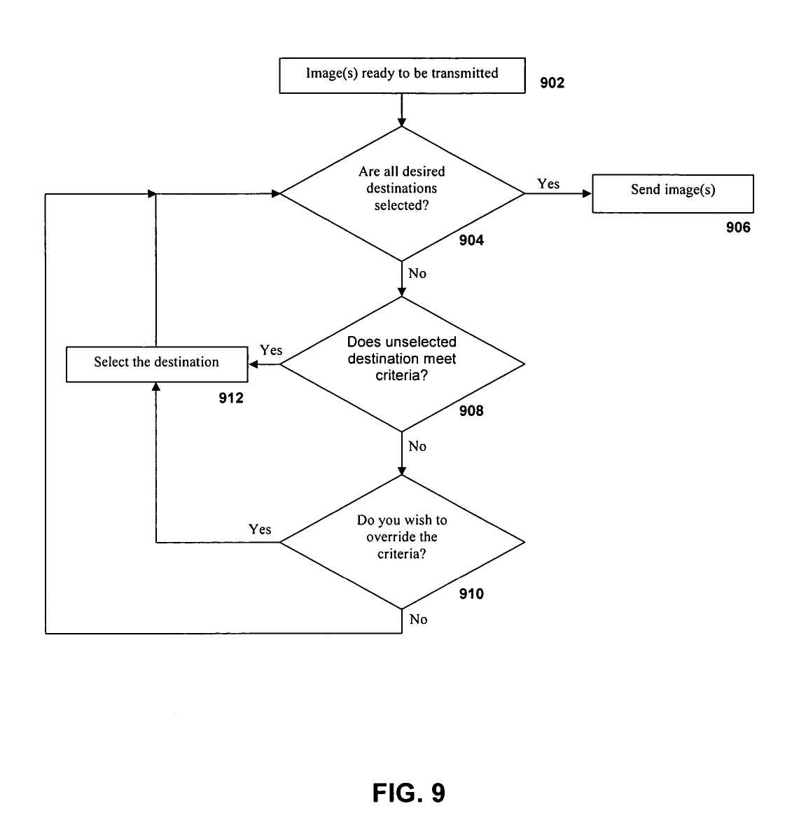

A method of processing and routing images and studies within system 100 according to one embodiment of the present invention is depicted in the flowchart of FIG. 9. After an image is scanned and ready to be transmitted at step 902, a user determines if all the user's desired destinations are selected at step 904. This determination can be made in one embodiment by consulting GUI 302 of scanner 110. In general, the smart destination image routing system of scanner 110 will look at each of the destinations under selected criteria and automatically pre-select certain destinations meeting the criteria prior to or as part of step 904. Any destinations not meeting the criteria will not be selected.

If, after reviewing the pre-selected destinations, a user determines that of all user's desired destinations have been selected, the user can then instruct the system to send the image(s) onto network 120 at step 906 to be picked up by the appropriate devices. If a user determines at step 908 that not all of the desired destinations have been selected by the system, however, even though the unselected destinations do not meet the criteria, the user can override the system and select or de-select the desired or undesired destinations at steps 910 and 912. Once the user has verified that all of the desired destinations are selected, the user can prompt the system to send the image(s) onto network 120 at step 906 to be picked up by the appropriate devices.

The smart destination image routing system of the present invention, implemented in one embodiment by a microprocessor of a scanner in a medical imaging system, therefore provides an intuitive and convenient system for handling and managing medical images and studies. The smart destination image routing system offers many advantages, including enabling a user to easily edit destinations within the medical imaging system or to set up image routing criteria without having to open and manually edit the code in a configuration file of the microprocessor. While compatible with imaging systems in general, such as medical studies and images including medical or dental x-rays, or non-medical images, the invention is particularly suited for and has been described with reference to mammography images.

Although the present invention has been described with reference to particular embodiments, one skilled in the art will recognize that changes can be made in form and detail without departing from the spirit and the scope of the invention. Therefore, the illustrated embodiments should be considered in all respects as illustrative and not restrictive.

What is claimed is:

1. A smart destination mammogram image scanning system comprising:
one or more mammogram image handling devices adapted to receive a digital mammogram image;
a communication network communicatively coupling the one or more mammogram image handling devices; and
a scanning device communicatively coupled to the communication network and comprising
an optical scanner adapted to scan a hardcopy mammogram film and create a digital mammogram image, and
a microprocessor comprising programming means for presenting a graphical user interface (GUI) comprising a destination editor,
wherein the destination editor comprises a selectable indicator associated with each of the one or more mammogram image handling devices, and wherein the scanner is adapted to transmit the digital mammogram image to each of the one or more mammogram image handling devices for which the selectable indicator is selected.

2. The smart destination mammogram image scanning system of claim 1, wherein the GUI further comprises a destination criteria editor associated with each of the one or more mammogram image handling devices, the destination criteria editor comprising at least one customizable criterion related to the hardcopy mammogram film and the digital mammogram image, wherein the scanner is further adapted to transmit the digital mammogram image to each of the one or more mammogram image handling devices for which the customizable criterion related to the hardcopy mammogram film and the digital mammogram image corresponds.

3. The smart destination mammogram image scanning system of claim 2, wherein the customizable criterion is selected from the group consisting of: a patient demographic; a date of the hardcopy mammogram film; a date of the digital mammogram image; a physician identifier; and an examination type keyword.

4. The smart destination mammogram image scanning system of claim 3, wherein the examination type keyword customizable criterion comprises a free text field in the destination criteria editor.

5. The smart destination mammogram image scanning system of claim 1, wherein the one or more mammogram image handling devices comprise Digital Image and Communications in Medicine (DICOM) system Service Class Providers (SCPs).

6. The smart destination mammogram image scanning system of claim 5, wherein the SCPs comprise devices selected from the group consisting of a Picture Archiving and Communications System (PACS); a computer-aided diagnosis (CAD) system; a digital softcopy workstation; and a CD/DVD burner.

7. The smart destination mammogram image scanning system of claim 1, wherein the selectable indicator associated with each of the one or more mammogram image handling devices comprises a name of the mammogram image handling device.

8. The smart destination mammogram image scanning system of claim 7, wherein the name is user-specified.

9. A method of routing digital mammogram images comprising the steps of:
associating at least one identifier with a digital mammogram image;
selectively associating at least one criterion with a destination in a graphical user interface (GUI) configuration editor;
evaluating the at least one identifier of the digital mammogram image and the at least one criterion; and
routing the digital mammogram image to the destination if the at least one identifier of the digital mammogram image corresponds with the at least one criterion of the destination.

10. The method of claim 9, further comprising the step of:
creating a digital mammogram image from a hardcopy mammogram film.

11. The method of claim 9, further comprising the step of:
manually overriding the at least one criterion to route the digital mammogram image to a destination if the at least one identifier of the digital mammogram image does not correspond with the at least one criterion of the destination.

12. The method of claim 9, wherein the step of associating at least one identifier further comprises:
associating at least one identifier with a digital mammogram image, wherein the identifier is selected from the group consisting of: a patient demographic; a date of the hardcopy mammogram film; a date of the digital mammogram image; a physician identifier; and an examination type keyword.

13. The method of claim 9, wherein the step of selectively associating at least one criterion further comprises:
selectively associating at least one criterion with a destination in a GUI configuration editor, wherein the criterion is selected from the group consisting of: a patient demographic; a date of the hardcopy mammogram film; a date of the digital mammogram image; a physician identifier; and an examination type keyword.

14. A smart destination mammogram image routing system comprising:
means for associating at least one identifier with a digital mammogram image;
user interface means for selectively associating at least one criterion with a destination;
means for evaluating the at least one identifier of the digital mammogram image and the at least one criterion; and
means for routing the digital mammogram image to the destination if the at least one identifier of the digital mammogram image corresponds with the at least one criterion of the destination.

15. The smart destination mammogram image routing system of claim 14, further comprising means for creating a digital mammogram image from a hardcopy mammogram film.

16. The smart destination mammogram image routing system of claim 14, further comprising means for manually overriding the at least one criterion to route the digital mammogram image to a destination if the at least one identifier of the digital mammogram image does not correspond with the at least one criterion of the destination.

17. The smart destination mammogram image routing system of claim 14, wherein the identifier and the criterion are each selected from the group consisting of: a patient demographic; a date of the hardcopy mammogram film; a date of the digital mammogram image; a physician identifier; and an examination type keyword.

18. The smart destination mammogram image routing system of claim 14, wherein the user interface means for selectively associating at least one criterion with a destination comprise a configuration editor in a graphical user interface (GUI).

19. The smart destination mammogram image routing system of claim 14, wherein the destination comprises a device selected from the group consisting of a Picture Archiving and Communications System (PACS); a computer-aided diagnosis (CAD) system; a digital softcopy workstation; and a CD/DVD burner.

20. The smart destination mammogram image routing system of claim 14, wherein the means for routing the digital mammogram image to the destination comprises a communications network.
